(19) United States
(12) Patent Application Publication
(10) Pub. No.: US 2007/0239714 A1
(43) Pub. Date: Oct. 11, 2007

(54) System and method for identifying new business partner

(75) Inventors: Fred Chen, Shanghai (CN); Tian Xu, Shanghai (CN)

Correspondence Address: KENYON & KENYON LLP, 1500 K STREET N.W., WASHINGTON, DC, 20005, US

(73) Assignee: SAP AG, Walldorf (DE)

(21) Appl. No.: 11/394,871

(22) Filed: Mar. 31, 2006

(51) Int. Cl. G06F 17/30

(52) U.S. Cl. 707/6

(57) ABSTRACT

A method for determining whether a business partner newly found by an external resource is the same as an existing business partner saved in an internal database before entering information of the newly found business partner into the database. Information about newly found business partner from external resources is temporarily stored in a sourcing pool. A business partner identifying unit compares the information of newly found business partner and information of existing business partners stored in an internal database and calculates a difference rate. The business partner identifying unit then compares the difference rate with an empirical value. According to the relationship between the difference rate and the empirical value, the business partner identifying unit decides whether to import the information about the newly found business partner to the database.

### BACKGROUND

A business can work with hundreds or thousands of business partners. These business partners may be customers, suppliers, or service providers, and may be companies or individuals. Such businesses often manage their activities using computer systems that execute various enterprise management applications. Within these computer systems, a business generates data records that store information, for example, regarding its business partners. For example, a business partner record may include a Business Partner Code and data regarding various attributes of the business partner. Such business partner records would be stored in an internal business partner database for use by the applications.

Management of data within the internal business partner database can involve substantial expense. A business may have several employee representatives that regularly solicit new business partners. Some of these efforts might be redundant. For example, one employee may solicit new contacts with a partner, think the partner is new, but which has in facts already been registered in the internal business partner database. Obviously, problems may occur if the business saves multiple data records representing the same business partner in the database. Additional problems and loss of revenue may occur, however, if the system fails to save a new partner record for a new business partner. For large implementations, system users must spend considerable time to determine whether a newly found business partner is related to an existing business partner record already saved in the database or whether the newly found business partner has not been stored in any partner record within the database. If the newly found business partner is “truly new,” a new business partner record should be created in the database and a new business partner code should be assigned.

Given the high expense of manually reviewing a large database of business partner records, there is a need in the art for a method and system for automatically recognizing existing business partners and distinguishing new business partner from existing business partner.

### BRIEF DESCRIPTION OF THE DRAWINGS

FIG. 1 illustrates a block diagram of a system for identifying a new business partner according to an embodiment of the present invention.

FIG. 2 illustrates a flowchart of a method for identifying a new business partner according to an embodiment of the present invention.

### DETAILED DESCRIPTION

The present invention provides a method for determining whether a newly found business partner, believed to be new by a user of the business partner database, matches an existing business partner record already saved in an internal business partner database or whether the newly found business partner is likely to be truly new, therefore, needs to be stored into the business partner database as a new record. Information about the newly found business partner is stored in a temporary memory, called a “sourcing pool.” A business partner identifying unit compares the information stored in the sourcing pool against information of each existing business partner record already stored in the business partner database and calculates a difference rate between them. The business partner identifying unit then compares the difference rate with an empirical value. Based on the empirical value, the business partner identifying unit decides whether to import the information from the sourcing pool to the database automatically.

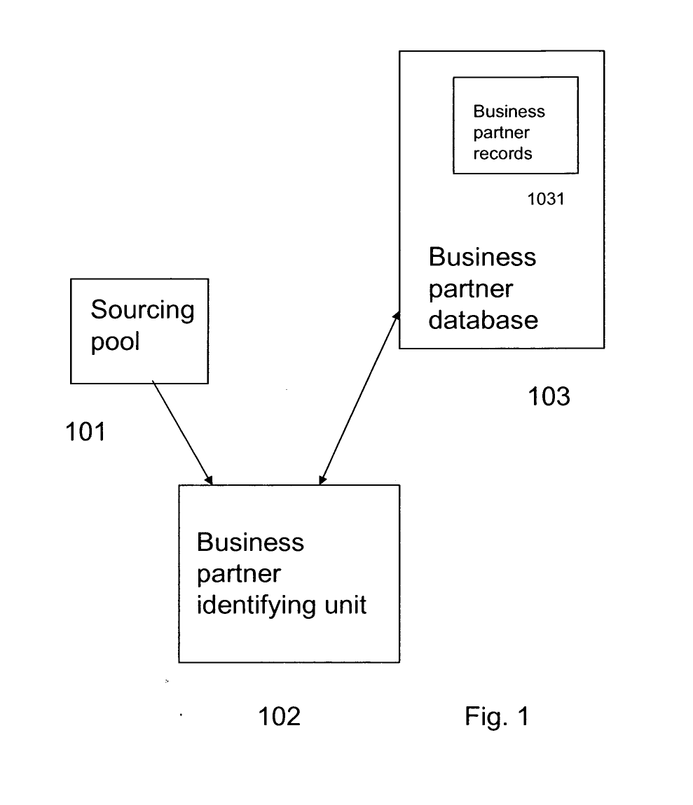

FIG. 1 illustrates a block diagram of a system 100 according to an embodiment of the present invention. The system 100 may include a sourcing pool 101, a business partner identifying unit 102 and a business partner database 103. As indicated, the sourcing pool 101 may store temporarily information about a newly found business partner. The business partner database may store partner records 1031 about existing business partners already registered with the system. The business partner identifying unit 102 may perform comparisons between data in the sourcing pool 101 and partner records 1031 in the database 103 to determine whether the information in the sourcing pool 101 is likely to represent a new business partner.

More specifically as described below, the business partner identifying unit 102 may compare the information in the sourcing pool 101 against each existing business partner record stored in the business partner database 103 and calculates difference rates for each comparison. The business partner identifying unit 102 may compare the difference rates for each comparison against a threshold from which it may determine whether to import the information in the sourcing pool to the database 103 automatically.

As noted, the database 103 stores partner records representing information of existing business partners. Partner records may include data such as an identification number, like a Business Partner Code, contact information and the like.

In an embodiment, the sourcing pool may receive data regarding newly identified business partners from automated, external data sources. Exemplary data sources can include for example, the Internet, search engines, a B2B website, application programs, a file or another database. In this embodiment, the system 100 may be a completely autonomous system which can populate the business partner database 103 with minimal (or no) manual oversight.

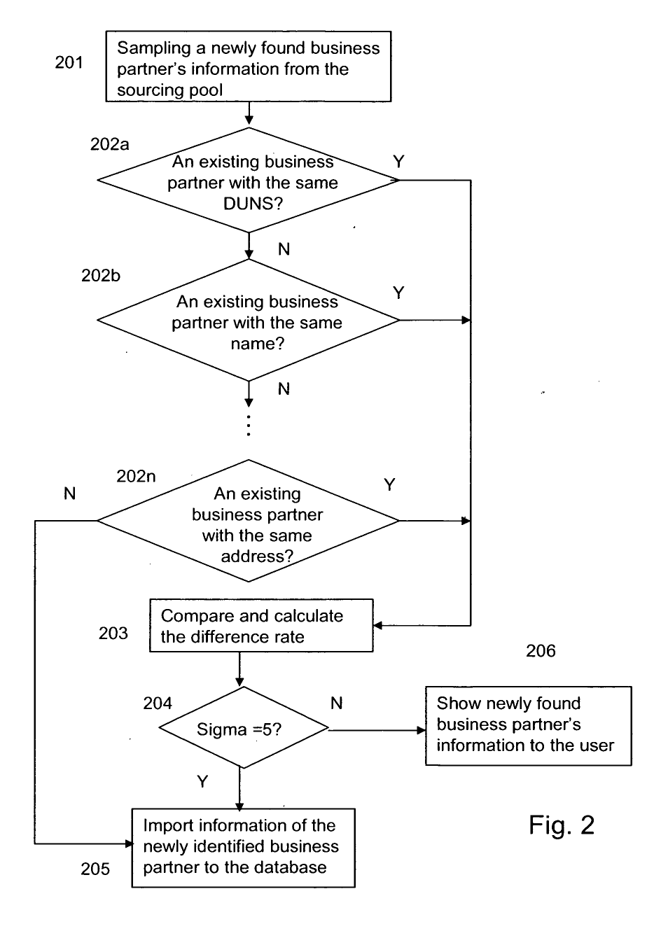

FIG. 2 illustrates a flowchart of a method 200 for identifying a new business partner according to an embodiment of the present invention. At 201, the business partner identifying unit 102 may sample information about a newly found business partner in the sourcing pool. From 202a, 202b to 202n, the business partner identifying unit 102 searches the database 103 for existing business partner records having information similar or relevant to the sampled partner data. In one embodiment, at 202a, the business partner identifying unit 102 may identify the most distinctive identifying information available in the sourcing pool (e.g., a Data Universal Numbering System (DUNS) number or a tax ID) and search for correspondence in the database 103. If an existing business partner record from the database matches the distinctive identifier from the sourcing pool 101, the process may proceed to box 203. Otherwise, at 202b, the business partner identifying unit 102 may search the database 103 with the next most distinctive identifying information available from the sourcing pool 101 (e.g., the partner's name). Again, if a match occurs, the process may proceed to box 203. Otherwise, the business partner identifying unit 201 may search the database with other distinctive identifying information in the sourcing pool 101 (e.g., telephone number, fax number, website address, contact person, registered investment, and/or address) for correspondence in the database 103. If no existing business partner records are found with similarity to the newly identified business partner data in the sourcing pool, the partner data in the sourcing pool may be assigned a Business Partner Code and saved as a new partner record in the database at 205.

In the embodiment in FIG. 2, even if a newly found business partner and an existing business partner in the internal database have the same DUNS number or the same name, the business partner identifying unit need not automatically regard them as the same company. Instead, the business partner identifying unit may verify the accuracy of the DUNS number by calculating a difference rate between the sampled data for newly found business partner in the source pool 101 and the existing business partner record to account for possible errors in the DUNS number or name of the newly found business partner. The search at 202a to 202n is to look for an existing business partner in the internal database 203 to be compared with a newly found business partner in the sourcing pool.

On the other hand, if an existing business partner in the database has some information similar to that of the newly found business partner, the business partner identifying unit 102 may calculate a difference rate between the two at 203. As shown in Table 1, the business partner identifying unit may put the information of a business partner into a certain sequence, and matches information of the newly found business partner and the existing business partners. At box 203, the business partner identification unit compares the same type of information of the newly found business partner and the existing business partner, i.e., company name is compared with company name, industry is compared with industry, etc.

TABLE 1

| Company in the Sourcing Pool | Company in the Database |
|---|---|
| Company name | Company name |
| Industry | Industry |
| Address | Address |
| Telephone number | Telephone number |
| Fax number | Fax number |
| DUNS number | DUNS number |
| . . . | . . . |

On a field basis, the value a may denote the number of instances where there is a match between field data of sampled data of newly identified business partner and corresponding field data of an existing business partner record. For example, if a company name for the newly found business partner matches the company name for an existing business partner, a may be assigned a value of 0 (i.e., a=0). Otherwise, a=1.

In one embodiment, different fields (e.g., different types of partner information) may be assigned different weighting levels according to their distinctiveness and/or importance. For example, DUNS data often is considered the most distinctive identifying information available for a company, so its weighting level may be set to DIF=5. The industry of a company generally may be considered less distinctive than the DUNS number and, therefore, may be assigned a weighting level of DIF=4. Similarly, the company name may be assigned a weighting level DIF=3, address data may be assigned a weighting level DIF=2, and the telephone and fax number may be assigned weighting levels of DIF=1.

The weighting levels given here are for examples only. It should be understood that different identifying information could be used, e.g., the company's website, contact person, registered investment. In addition, the weighting level DIF could be assigned differently.

Then the business partner identifying unit 102 may calculate a difference rate between the two sets of business partner data. In one embodiment, the difference rate, Sigma, is calculated according to the following formula:
Sigma={square root over (Σ(DIF*α)²))} (1)
wherein DIF represents the weighting level, and a represents whether certain type information of the newly identified business partner in the sourcing pool and of the existing business partner in the database is the same.

In one example, an existing business partner in the database has a name similar to the newly found business partner, as shown in Table 2.

TABLE 2

| | Internal | External |
|---|---|---|
| Supplier number | 06101 | |
| Company name | AKRON | AKRON LTD. |
| Industry | IM&C, CP | |
| Address | 1108 W. North Street | |
| Tel Number | (330) 7330 0 | |
| Fax Number | (330) 7330 1 | |
| D-U-N-S Number | 54-475-0501 | |

In this example, the only information available for the newly found business partner is its name, which is similar to an existing business partner in the database. Since the two names are not exactly the same, a=1, and the weight level of the company name is 3. Thus, the difference rate between the two business partners is:
Sigma=√(Σ(DIF*a)²)=√(Σ((3*1)²)=3

In this embodiment, if a certain type of information is missing, the business partner identifying unit need not consider it.

In an example shown in Table 3, the newly found business partner has the same name with an existing business partner in the database, but the two business partners have different DUNS numbers.

TABLE 3

| | Internal | External |
|---|---|---|
| Supplier code | 06101 | |
| Company name | AKRON | AKRON |
| Industry | IM&C, CP | |
| Address | 1108 W. North Street | |
| Tel Number | (330) 7330 0 | |
| Fax Number | (330) 7330 1 | |
| D-U-N-S Number | 54-475-0501 | 54-475-0502 |
| . . . | | |

The two business partners have the same company names, thus for company name, a=0. The weighting level for company name is DIF=3.

The two business partners have different DUNS numbers, thus for DUNS numbers, a=1. The weighting level for the DUNS number is 5. Thus, the difference rate between the two business partners is:
Sigma=√(Σ(DIF*a)²)=√(Σ((3*0)²,(5*1)²)=5

In the example shown in Table 4, the newly found business partner and the existing business partner in the database have the same industry, telephone number and fax number, but have different name and address.

TABLE 4

| | Internal | External |
|---|---|---|
| Supplier code | 06101 | |
| Company name | AKRON | AKRON Ltd. |
| Industry | IM&C, CP | IM&C, CP |
| Address | 1108 W. North Street | 1110 W. North Street |
| Tel Number | (330) 7330 0 | (330) 7330 0 |
| Fax Number | (330) 7330 1 | (330) 7330 1 |
| D-U-N-S Number | 54-475-0501 | |
| . . . | | |

Following the same analysis of Table 2 and Table 3, the difference rate of the two company is:
Sigma=√(Σ(DIF*a)²)=√(Σ((3*1)²,(4*0)²,(2*1)²,(1*0)²,(1*1)²))=3.74

It should be understood that the formula for calculating the difference rate is for example only. Other types of formula could be used.

At 204, the difference rate may be compared with an empirical number. In one embodiment, the empirical number is 5. If the difference rate is not smaller than 5, the two business partners may be considered absolutely different, and the newly found business partner may be assigned a Business Partner Code and its information will be imported to the database automatically at 205. If the difference rate is smaller than 5, at 206, the business partner identifying unit my show the information of the two business partners to the user of the business partner database, so that he can look at the information himself and decide whether to import the information of the newly identified business partner in the sourcing pool to the database.

To further support the user's decision making, in one embodiment, if 5>sigma>3, the business partner identifying unit may show the information of the two business partners to the user, and may prompt the user to consider whether the data in the sourcing pool 102 shall be saved in the database 103 as a new business partner. If the difference rate is not bigger than 3, the business partner identifying unit decides that the two business partners are likely to be the same, and need not show their information to the user.

While the invention has been described in detail above with reference to some embodiments, variations within the scope and spirit of the invention will be apparent to those of ordinary skill in the art. For example, although the embodiment are described with companies, the business partner could be individuals as well. If the business partners are individuals, the identifying information could be their name, ID number, profession, etc.

What is claimed is:

1. A method for identifying a business partner, comprising:
receiving at least one attribute of a first entity;
comparing the at least one attribute of the first entity with a corresponding attribute of a second entity previously stored in an existing database;
calculating a difference rate between the first entity and the second entity, and
if the difference rate exceeds a first predetermined threshold, storing the first entity as a new business partner.

2. The method of claim 1, further comprising assigning a weighting level to the at least one attribute.

3. The method of claim 2, wherein the difference rate is calculated with the weighting level of the at least one attribute.

4. The method of claim 2, wherein the at least one attribute is a Data Universal Numbering system (DUNS) number of a company.

5. The method of claim 2, wherein the at least one attribute is an Identification number of a person.

6. The method of claim 2, wherein the first predetermined threshold is an empirical value.

7. The method of claim 2, further comprising presenting attributes of the first and second entity to a user of the existing database to enable the user to decide whether the first entity is a new business partner when the difference rate is between the first predetermined threshold and a second predetermined threshold.

8. A system for identifying a business partner, comprising:
a memory storage unit for temporarily storing at least one attribute of a first entity;
an existing database for storing at least one attribute of a second entity; and
a business partner identification unit for comparing the at least one attribute of the first entity with the corresponding attribute of the second entity, and calculating a difference rate between the first entity and the second entity.

9. The system of claim 8, wherein the business partner identification unit further assigns a weighting level to the at least one attribute.

10. The system of claim 9, wherein the business partner identification unit calculates the difference rate with the weighing level to the at least one attribute.

11. The system of claim 9, wherein the business partner identification unit further compares the difference rate with an empirical value.

12. The system of claim 11, wherein the business partner identification unit further determines that the first entity is a new business partner when the difference rate and the empirical value meet a first requirement.

13. The system of claim 12, wherein the business partner identification unit further saves the first entity into the existing database if it is a new business partner.

14. The system of claim 11, wherein the business partner identification unit further determines that the first entity is not a new business partner when the difference rate and the empirical value meet a second requirement.

15. The system of claim 11, wherein the business partner identification unit further presents attributes of the first and second entity to a user to enable the user to decide whether the first entity is a new business partner.

16. A method to determine whether to admit a new data record into a database, comprising:
receiving data representing a potentially new business partner, comparing the received data against data records of previously stored business partners, wherein the data of the potentially new business partner and the data records each include respective sets of attributes, and wherein the comparison compares like-kind attributes from the received data and the data records when data in the respective attributes is non-null;
based on the comparison, determining whether a similarity exists between the received data and at least one of the records; and
if the received data is dissimilar to all the previously stored data records, storing the received data in the database.

17. The method of claim 16, further comprising assigning a new business partner code to the received data when storing the received data in the database.

18. The method of claim 16, further comprising assigning a weighting level to an attribute.

19. The method of claim 18, wherein the similarity is determined by calculating a difference rate with:
{square root over (Σ(DIF*α)²))},
wherein DIF is the weighting level of an attribute, and a=1 when an attribute of the potentially new business partner is different from a like-kind attribute of a previously stored data record.

20. The method of claim 19, wherein the received data is dissimilar to a previously stored data record if the difference rate exceeds a predetermined threshold.
